(19) United States
(12) Patent Application Publication
(10) Pub. No.: US 2003/0056622 A1
(43) Pub. Date: Mar. 27, 2003

(54) Tool for removing damaged fasteners and securing new fasteners and improved method for making such tool

(76) Inventor: Chalmer C. Jordan, Saegertown, PA (US)

Correspondence Address: Cohen & Grigsby, P.C., 15th Floor, 11 Stanwix Street, Pittsburgh, PA, 15222, US

(21) Appl. No.: 10/225,727

(22) Filed: Aug. 22, 2002

Related U.S. Application Data
(63) Continuation-in-part of application No. 10/007,223, filed on Nov. 2, 2001.
Application No. 10/007,223 is a division of application No. 09/439,211, filed on Nov. 12, 1999, now Pat. No. 6,339,976.

(51) Int. Cl. B25B 13/50

(52) U.S. Cl. 81/53.2

(57) ABSTRACT

A tool for removing damaged fasteners and a method for making such tool wherein the tool (10) includes a first end (12) and a second end (14) with an outside surface (32) and an inside surface (40) defined between ends (12) and (14). A portion (46) of inside surface (40) is in the shape of a hexagonal frustum (54) that has a major end (58) and that includes spiral splines (25). Splines (25) have constant depth between the major end (58) and the minor end (56) of frustum (54) and the relief angle (£) of splines (25) increases in the direction from minor end (56) toward major end (58). In the method for making the tool (10), a tubular section (118) is made from a tapered blank (91) by piercing one end of the tapered blank with a pierce punch (132). One end of the tubular section is then driven onto a splined punch (162) to provide a splined tubular section (165) having splines in one end. The splined tubular section is then stripped off of the punch (162) by a kick-out sleeve (166) and extruded through a round-to-hexagonal extrusion insert (182) to provide a splined polygonal section (173) having an inner surface with a tapered, hexagonal shape. A modified round-to-hexagonal extrusion insert (206) provides a tool with corners (202) on the polygonal surface. A modified tool (310) with splines (325) in a clockwise spiral is used to secure tamper-resistant fasteners. The modified tool (310) is made by substituting a clockwise splined punch (462) in the tool-making method.

### REFERENCE TO PRIOR RELATED APPLICATION

This application is a continuation-in-part of U.S. application Ser. No. 10/007,223 which was filed on Nov. 5, 2001, which is a divisional application of Ser. No. 09/439,211, which was filed on Nov. 12, 1999, now U.S. Pat. No. 6,339,976 by Chalmer C. Jordan, an individual, who is also an inventor in this application.

### BACKGROUND OF THE INVENTION

1. Field of the Invention

The presently disclosed invention relates to tools for removing or securing threaded fasteners and, more particularly, tools for removing fasteners wherein the perimeter surface of the fastener has been damaged by corrosion or mechanical stress such that the corners of the polygonal surface have become rounded. The disclosed invention also relates to tools for securing fasteners that are intended for tamper-resistant applications.

2. Description of the Prior Art

Many types of threaded fasteners are known in the prior art. Such fasteners have various designs for cooperation of the fastener with a threaded member. Some of these fasteners, such as wing nuts or thumbscrews, are intended to be applied and removed without the use of tools. Other fasteners, such a threaded nuts, require the use of tools for their application and removal.

In particular, many types of fasteners have an inner threaded surface and an outer polygonal surface, typically a hexagonal surface. The inner threaded surface cooperates with the threaded member and the outer surface cooperates with a tool that is used to apply or remove the fastener from the threaded member. Various types of tools have been developed and used for this purpose. Examples are shown and described in U.S. Pat. Nos. 4,328,720; 4,671,141; and 4,993,289. Basically, these tools cooperate with the polygonal sides of the fastener to transfer a torque force that is required to turn the fastener on and off of a bolt or other threaded member.

There has been a persistent problem with the polygonal-style threaded fasteners in the prior art. When the polygonal sides become worn or damaged, the sides no longer define the requisite shape that is necessary for the fastener to cooperate with the tool that is designed for its application and removal. Frequently this problem arises when the fastener is to be removed and the polygonal sides have been damaged due to corrosion or mechanical wear. In this situation, the conventional tools that are designed for the removal of the fastener are no longer operative. Generally, the conventional tool will merely slip over the rounded or damaged corners between the polygonal sides of the fastener so that the tool will not remove the fastener.

This difficulty has been recognized in the prior art wherein different types of tools have been developed for the removal of damaged polygonal fasteners from their threaded members. Examples of such tools are shown and described in U.S. Pat. Nos. 3,996,819 and 5,551,320. U.S. Pat. No. 3,996,819 is directed to a wrench socket wherein a number of raised teeth are arranged in a conical-shaped opening in the tool. The teeth are aligned angularly within the conical opening. As the tool is turned to remove the fastener, the teeth engage the fastener and cause the tool to transfer torque to the fastener so that it can be removed. U.S. Pat. No. 5,551,320 is directed to an improved tool for removing damaged fasteners. In this tool, a plurality of teeth also engage the fastener for the purpose of removing the damaged fastener from the threaded member.

One difficulty with the tools for removing damaged fasteners as known in the prior art was that the tools could not be readily manufactured in accordance with conventional manufacturing processes. Machining the individual teeth into a tool body such as described in U.S. Pat. Nos. 3,996,819 and 5,551,320 was not practical on a commercial scale. Broaching the teeth into the tool body was also found to be unworkable because the geometry of the tool caused the broach to seize in the tool. This resulted in the destruction of either the broach or the tool, or both.

Accordingly, there was a need in the prior art for a commercial manufacturing method that could be practiced to manufacture tools for removing damaged threaded fasteners. In particular, there has been a need in the prior art for a commercially practical method of manufacturing tools for removing damaged threaded fasteners where the tool meets standard industrial specifications that are applicable to fasteners of the corresponding type.

Also in the prior art, various styles and types of fasteners have been developed for applications wherein it is intended to defeat unauthorized parties from tampering with fastener. Many versions of such “tamper-resistant” fasteners and special tools for their application have been developed. However, for various reasons, the need for more effective tamper resistant fasteners and tools for applying such fasteners has persisted in the prior art.

### SUMMARY OF THE INVENTION

In accordance with the invention, an improved tool for removing damaged fasteners and an improved method for making such tool from a cold metal forming process is disclosed herein. According to the tool and process herein disclosed, the tool is cold formed from a tubular section that has a tapered outer surface and a cylindrical inside surface with helical splines thereon. The splined tubular section is extruded through a round-to-polygonal die insert to cold form the tapered outer surface of the splined tubular section to a polygonal surface wherein adjoining sides of the polygonal surface join together in a radiused edge. Preferably, the round-to-polygonal die insert has an internal passageway with a portion of such passageway defined by inwardly bowed internal walls.

In the cold forming process, the tubular section is driven onto a floating punch that has helical splines at the working end of the punch. The floating punch has a substantially constant radius and is secured in the longitudinal dimension with respect to the die plate, but is freely rotatable in the angular direction. As the tubular section is driven onto the punch, the punch angularly rotates in response to the longitudinal movement of the tubular section and in accordance with the pitch of the helical splines. The tubular section rotates in a first direction in accordance with the direction of the splines on the punch to form a splined tubular section having helical splines at one end of the inside surface of the tubular section.

After the splines are formed in the inside surface of the splined tubular section, the splined tubular section is stripped off of the end of the floating punch. As the splined tubular section is stripped off the end of the floating punch, the punch angularly rotates in the direction that is opposite from the first angular direction. In this way, the splined tubular section is removed from the floating punch while preserving the helical splines on the inner surface of the splined tubular section.

After the splined tubular section is stripped off of the floating punch, it is extruded through a round-to-polygonal extrusion die insert to form a splined polygonal section. This step cold forms the tapered outer surface of the splined tubular section to a polygonal surface of the splined polygonal section wherein adjoining sides of the polygonal surface meet together in a radius edge. At least a portion of the polygonal surface has a constant cross-section along the longitudinal axis of the splined polygonal section. This step also cold forms the cylindrical inside surface of the splined tubular section to an inside surface of the spinal polygonal section that is tapered and polygonal with one end having the internal splines. The direction of the taper of the inner surface of the splined polygonal section provides an inner surface having the largest cross-section at the end of the splined polygonal section having the splines.

Also preferably, the round-to-polygonal extrusion die insert defines an internal passageway wherein at least a portion of the surface of the passageway includes internal sides that are bowed inwardly in the radial direction. Most preferably, the internal sides that are bowed radially inwardly are superimposed in a portion of the internal passageway that is the shape of a circular frustum.

Also in accordance with the disclosed invention, it has been found that a tool made in accordance with a modification of the disclosed method is useful for securing threaded fasteners of the tamper-resistant type. The modified tool includes a first end and a second end that is oppositely disposed on the tool body from the first end. The tool has an outside surface that is defined between the first and the second ends. In addition, the tool has an inside surface that defines a closed passageway between the first and second ends. A portion of the inside surface that is adjacent to the second end is a polygonal surface that defines a central opening with the area of the central opening decreasing as the longitudinal position away from the second end increases. The portion of the inside surface that is adjacent to the second end also includes a plurality of clockwise spiral splines that extend radially inward.

Also preferably, the tool made in accordance with the modification of the disclosed invention further includes extrusion of the splined tubular section through a round-to-polygonal extrusion die that has an internal passageway, the passageway having sides that bow radially inwardly to project into the passageway.

Other features, objects and advantages of the disclosed invention will become apparent to those skilled in the art as a presently preferred embodiment of the disclosed tool and a presently preferred method of making the same proceeds.

### BRIEF DESCRIPTION OF THE DRAWINGS

The presently disclosed invention is shown and described in connection with the accompanying drawings wherein:

FIG. 1 is an elevation view of a tool in accordance with the disclosed invention with portions thereof broken away to better disclose the structure;

FIG. 2 is a bottom view of the tool shown in FIG. 1;

FIGS. 3A-3F is a layout drawing showing the tooling that is used in the stations of a cold forming machine in accordance with a presently preferred method of making the tool that is shown in FIGS. 1 and 2 herein;

FIGS. 4A-4F are cross-sections of the tool as it is formed at the stations of the cold forming machine as is illustrated in FIGS. 3A-3F respectively;

FIG. 5 is a bottom view of a tool that is similar to the tool that is shown in FIGS. 1 and 2 and that incorporates further improvements in accordance with the disclosed invention;

FIG. 5A is a cross-section of the tool of FIG. 5 as it is formed at station F of the cold forming machine.

FIG. 6 is an enlarged view of a round-to-polygonal insert that incorporates further improvements in accordance with the disclosed invention and that is used according to the improved method herein disclosed to produce the tool shown in FIG. 5;

FIG. 7 is a transverse cross-section of the round-to-polygonal insert that is shown in FIG. 6 taken along the lines 7-7 of FIG. 6;

FIG. 8 is an enlarged view of the round-to-polygonal insert that is shown in FIG. 7 to better disclose the details therein;

FIG. 9 is a transverse cross-section of the round-to-polygonal insert that is shown in FIG. 6 taken along the lines 9-9 of FIG. 6;

FIG. 10A is an elevation view of a modified tool for securing tamper-resistant threaded fasteners in accordance with the disclosed invention with portions thereof broken away to better disclose the structure;

FIG. 10B is bottom view of the tool shown in FIG. 10A; and

FIG. 11 is a layout drawing of tooling that shows a presently preferred process modification for making the modified tool shown in FIGS. 10A and 10B in accordance with the invention herein disclosed.

FIG. 11A is a cross-section of the tool shown in FIGS. 10A and 10B as it is formed at the station of the cold forming machine that is illustrated in FIG. 11.

### DESCRIPTION OF A PREFERRED EMBODIMENT

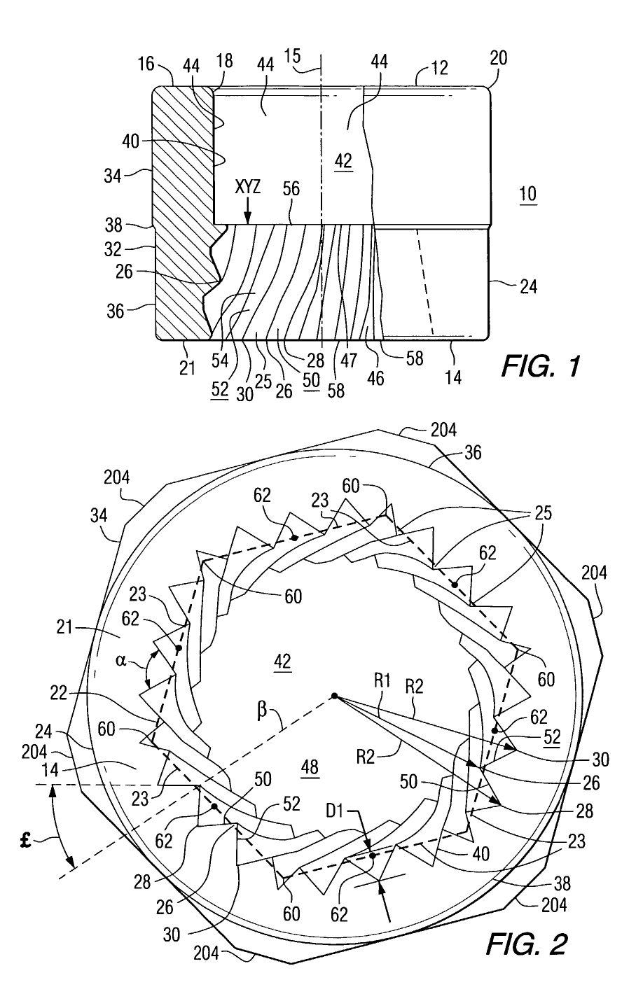

As shown in FIGS. 1 and 2, the presently disclosed tool 10 is used for the removal of nuts and other threaded fasteners from their corresponding bolts or equivalent threaded members. In particular, tool 10 is useful in the removal of threaded fasteners that have been damaged or corroded such that the outer surface of the fastener has been damaged and the fastener cannot be readily removed by wrenches, sockets or other tools that are designed for the removal of fasteners that are in good condition.

Tool 10 includes a first end 12 and a second end 14 that are aligned on a longitudinal center axis 15. First end 12 is in the general shape of a planar ring 16 that has a square inner edge 18 and a hexagonal outer edge 20. Second end 14 is in the general shape of a planar ring 21 that has a generally hexagonal inner edge 22 that includes hexagonal sides 23. Second end 14 further includes a circular outer edge 24. While inner edge 22 is hexagonal in the example of the preferred embodiment, it will be apparent to those skilled in the art that other polygonal shapes are also within the scope of the disclosed invention.

Hexagonal inner edge 22 includes a plurality of splines 25 that are directed radially inwardly towards the longitudinal center axis 15 of tool 10. Each of splines 25 are defined by a respective crest 26 that is located at a first radial position R1 from the longitudinal center axis 15 and two roots 28, 30 that are angularly located on opposite sides of crest 26. The radial position R2 of each of said roots 28, 30 from the longitudinal center axis 15 is greater than the radial position of R1 the crest 26.

First end 12 and second end 14 are oppositely disposed on the body of tool 10. An outside surface 32 is defined between first end 12 and second end 14. A portion 34 of outside surface 32 that is adjacent to first end 12 defines a hexagonal surface. That is, in portion 34 the cross-section that is orthogonal to the longitudinal center axis 15 has a hexagonal outside surface 32. A portion 36 of outside surface 32 that is adjacent to second end 14 defines a circular surface. That is, in portion 36 the cross-section of the body that is orthogonal to the longitudinal center axis 15 has a circular outside surface 32. Outside portion 34 and outside portion 36 are joined at a boundary 38.

An inside surface 40 between first end 12 and second end 14 defines a closed passageway 42 between the first and second ends. A portion 44 of inside surface 40 that is adjacent to the first end 12 defines a square recess that is adapted to receive the drive pin of a ratchet or other lever (not shown). A portion 46 of inside surface 40 that is adjacent to second end defines a hexagonal surface. A transition boundary 47 is established between portions 44 and 46. More specifically, portion 46 of inside surface 40 defines a central opening 48 wherein the cross-sectional area of the central opening taken orthogonally to longitudinal center axis 15 decreases as the longitudinal spacing from second end 14 increases. Accordingly, portion 46 of inside surface 40 defines a hexagonal frustum 54 having a minor end 56 that is located at the transition boundary 47 and a major end 58 that is located at the second end 14 of tool 10.

As also shown in FIGS. 1 and 2, splines 25 have a spiral shape and extend substantially throughout portion 46 of tool 10. As previously explained, splines 25 are defined by a crest 26 and roots 28, 30 that are disposed on opposite sides of crest 26. At any given position along longitudinal center axis 15, the radial position of roots 28, 30 from the longitudinal center axis are greater than the radial position of the crest 26.

The depth D1 of spline 25 is defined as the difference between R1, the radial position of crest 28, and R2, the radial position of roots 28 and 30, at a given location on the longitudinal center axis 15. In accordance with the presently disclosed invention, the depth D1 of the spline 25 is substantially constant at all longitudinal positions of the spline between minor end 56 and major end 58.

For each spline 25, crest 26 cooperates with each of roots 28, 30 to define sides 50 and 52 respectively. At a given longitudinal position defined by a plane that is orthogonal to the longitudinal center axis 15, each of sides 50 and 52 define an internal included angle α. The angle between the bisector β of the internal included angle α and either side 50 or 52 defines the relief angle £ of the spline at that longitudinal position. As shown in FIGS. 1 and 2, the relief angle £ for each of splines 25 progressively decreases in the longitudinal direction toward the minor end 56 of hexagonal frustum 54. Conversely, the relief angle £ for each of splines 25 progressively increases in the longitudinal direction toward the major end 58 of hexagonal frustum 54.

The shape of splines 25 in accordance with relief angle £ as herein described affords the tool herein disclosed an advantage over tools that are known in the prior art. Namely, because the relief angle £ for each of splines 25 decreases as the spline proceeds in the longitudinal direction toward the minor end 56 of hexagonal frustum 54, the point of spline 25 that engages or “bites” the nut or bolt that is to be removed is more acute or “sharper” at locations on spline 25 that are closer to the minor end 56 of hexagonal frustum 54 than locations on spline 25 that are relatively further away from minor end 56. The effect of this engagement of spline 25 with the nut or bolt that is to be removed is that the spline 25 tends to engage or “bite” into the nut or bolt more deeply and easily than prior art tools wherein splines (if any) tend to have a constant shape throughout their length.

Viewed from the end 14 of tool 10, each of spines 25 have a generally triangular cross-section wherein sides 50 and 52 converge to form an apical edge or crest 26. Adjacent hexagonal sides 23 are joined by corners 60. Each of hexagonal sides 23 also has a respective midpoint 62 that is located midway between the corners 60 that are on opposite ends of a hexagonal side 23. The radial position of said splines 25 with respect to the longitudinal center axis 15 decreases as the angular position of the crest 26 of said spline approaches the angular position of the midpoint 62 of the hexagonal side 23. In this way, even though the depth of each of the splines 25 is substantially the same, the splines that are closest to the respective midpoints 62 of hexagonal sides 23 are located at a shorter radial distance from the longitudinal center axis 15 than splines 25 that are located further away from the respective midpoints 62 of hexagonal sides 23.

In the use of tool 10, the tool is placed over a fastener that is to be removed from the associated threaded member. The tool 10 is positioned on the fastener such that the second end 14 of tool 10 passes over the outside perimeter of the fastener and splines 25 in the hexagonal frustum 54 of portion 46 engage the fastener.

Surprisingly, it has been found that the hexagonal shape of inside surface 40 of portion 46 affords improved operation of the disclosed tool in comparison to other tools known in the prior art. The splines 25 that are closest to the midpoint 62 of the hexagonal sides 23 engage the fastener while the splines 25 that are located away from midpoint 62 of the hexagonal sides 23 are held away from the fastener. That is because the midpoint 62 of the hexagonal sides is at a shorter radius from the longitudinal center axis 15 of the tool 10 than the corners 60. The splines 25 that are closest to the midpoint 62 engage the fastener before the splines that are located closer to corners 60.

When torque is applied to the tool 10 through a lever such as a ratchet (not shown) that is inserted into portion 44 of the inside surface 40 this arrangement provides for transfer of the torque to the fastener through less than all of the splines 25. (Alternatively, a wrench or socket (not shown) could also be used to engaged the tool externally and apply torque to the tool 10.) This causes the splines 25 that engage the fastener to bite into the fastener more deeply than arrangements wherein all of the splines initially engage the fastener. It has been found that this arrangement results in deeper engagement of the splines into the fastener and allows greater torque to be applied to the fastener.

Also in accordance with the invention disclosed herein is a preferred method for making tool 10 according to a cold forming process for tool manufacture. The presently disclosed method is practiced on a multi-station cold forming machine such as any of the types that are commercially available wherein the part is formed by sequentially passing the part through a plurality of forming stations. In the preferred embodiment, the stations are arranged in a linear array so that the part is processed at each station and then passed to the next station for further forming.

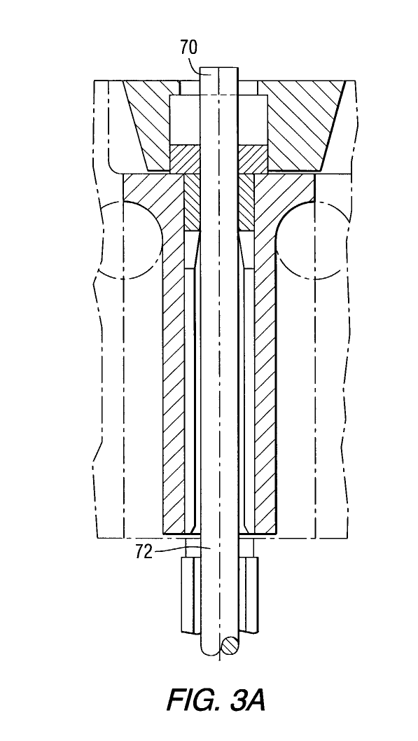

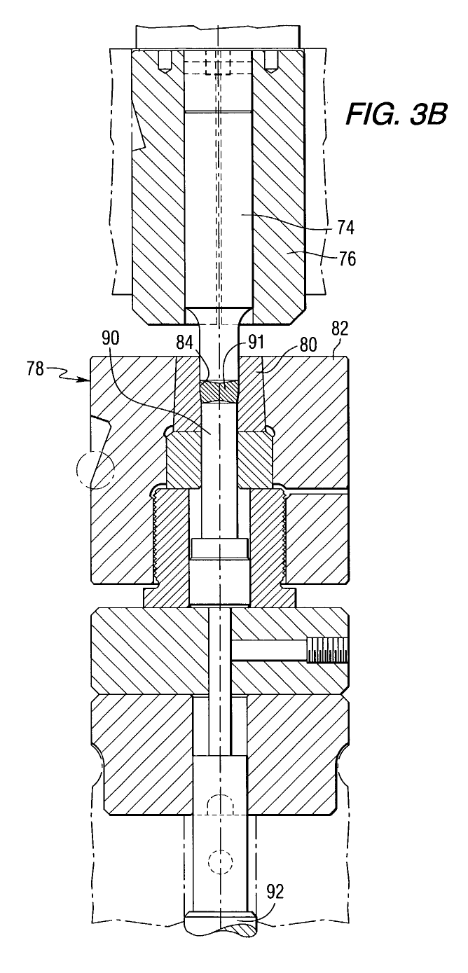

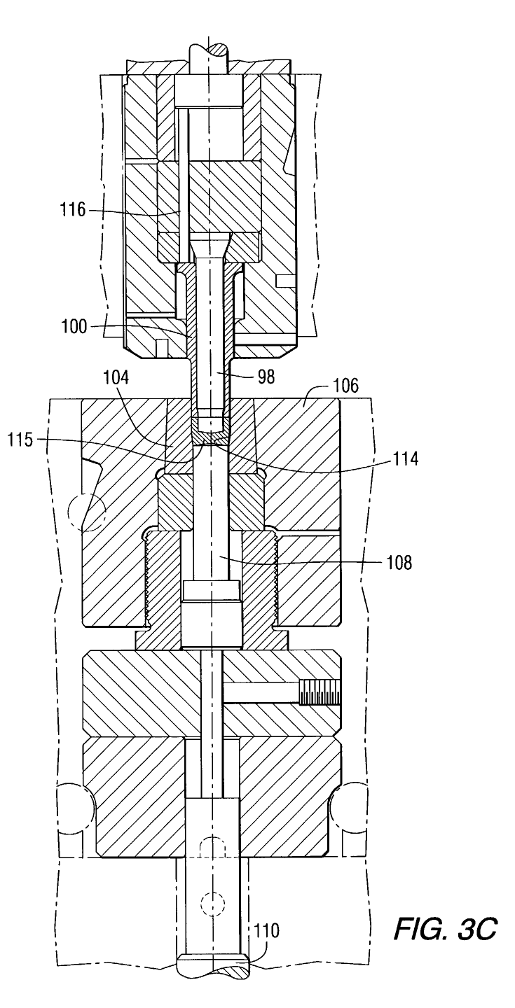

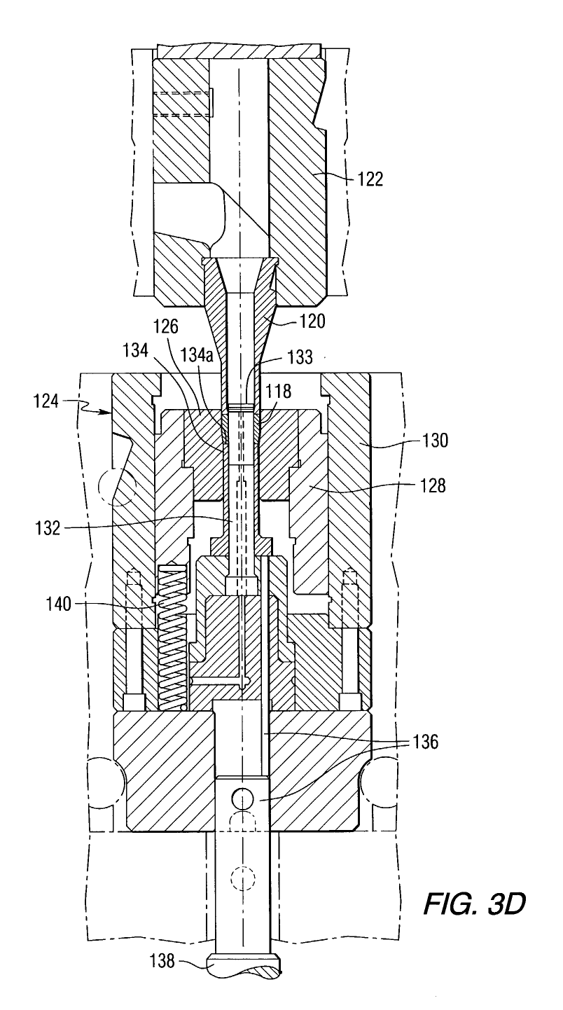

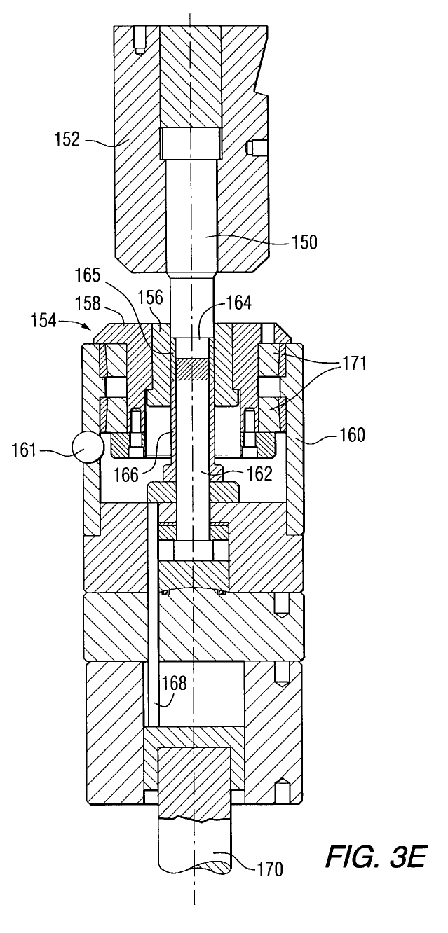

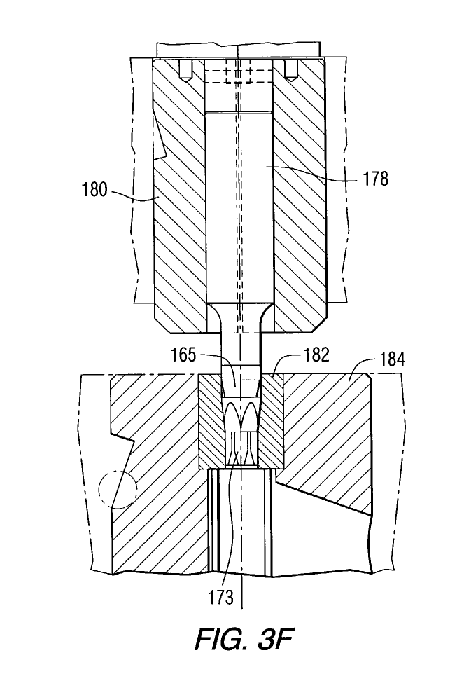

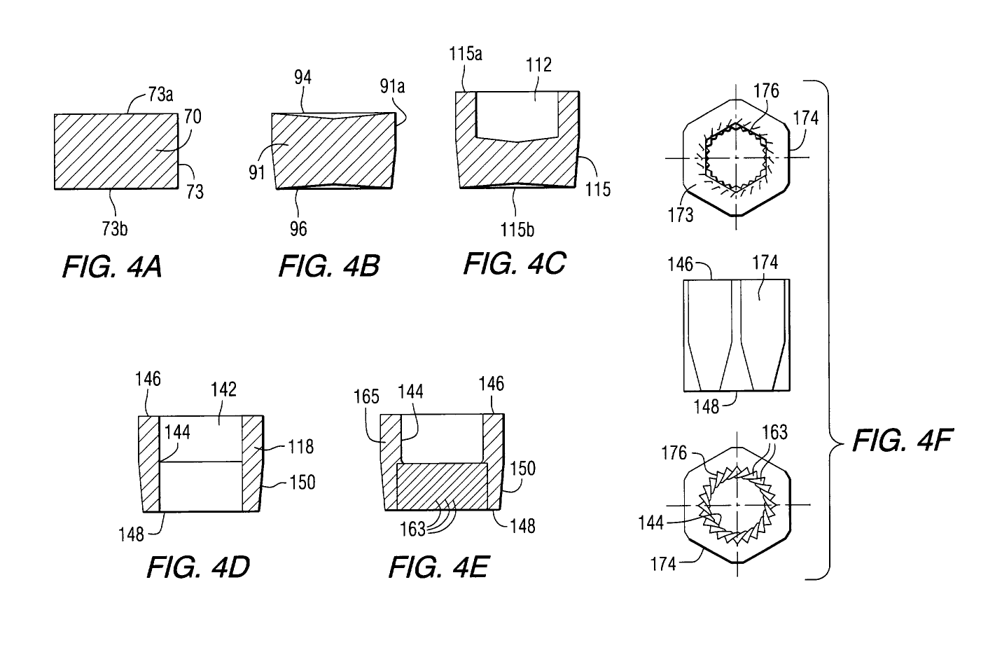

Cold forming machines such as described above are known to those skilled in the art who are familiar with the basic set up and operation thereof. The presently disclosed method is specifically directed to the particular arrangement of the process steps disclosed herein. The process is further described in connection with FIGS. 3A-3F and 4A-4F which show progressive changes in the part as it passes through the cold forming steps.

As shown in FIGS. 3 and 4, each of forming stations 3A through 3F comprise a cold forming station that has a punch assembly and a die assembly. As known to those skilled in the art, the commercially available cold forming machine has mechanisms for closing the punch assembly against the die assembly in coordination with the transfer of the partially finished part between stations.

As illustrated in FIGS. 3A and 4A, station A is a station wherein a solid blank 70 is cut from a wire line 72. Blank 70 has a cylindrical surface 73 that is defined between a first end 73a and a second end 73b.

At station B, the punch assembly includes a punch 74 that is mounted in a tool case 76. Also at station B, the die assembly includes a die 78 that includes a die insert 80 that is mounted in a die case 82. The blank 70 is located in the die insert 80 which defines a tapered internal passageway 84. Punch 74 strikes the first end 73a of blank 70 while the second end 73b of blank 70 is opposed by a kick-out pin 90. This causes the outer surface of blank 70 to become tapered in accordance with the shape of passageway 84 of die insert 80. Thus, tapered blank 91 is formed. Tapered blank 91 has a tapered outside surface 91a between a first end 94 and a second end 96. The area of first end 94 of the tapered blank 91 is larger than the area of second end 96. Thereafter, kick-out pin 90 is actuated by kick-out rod 92 to remove the tapered blank 91 from die insert 80.

Tapered blank 91 is transferred to station C wherein the punch assembly is provided with an extrusion punch 98 that is concentrically mounted inside a stripper sleeve 100. The extrusion punch 98 is actuated by the punch assembly and the stripper sleeve 100 is longitudinally actuated with respect to punch 98 by an intermediate kick-out pin 116.

At station C, the tapered blank 91 from station B is positioned in a die that includes a die insert 104 that is mounted in a die case 106. The extrusion punch 98 strikes the first end 94 of the tapered blank 91 while the second end 96 of the tapered blank 91 is opposed by a kick-out pin 108 that is longitudinally actuated by a kick-out rod 110. This action cold forms an extruded blank 115 having a first end 115a and a second end 115b. The extruded blank 115 has a well 112 that is formed in the first end 115a of extruded blank 115. Well 112 is formed by extruding material of tapered blank 91 between the perimeter of the extrusion punch 98 and the inside wall 114 of the die insert 104. Tapered blank 91 thus becomes extruded blank or well blank 115. Extruded blank 115 is then removed from die insert 104 by the longitudinal action of the kick-out pin 108 and the kick-out rod 110. Well blank 115 is removed from the end of the extrusion punch 98 by the longitudinal extension of an intermediate pin 116 that cooperates with the stripper sleeve 100. Intermediate pin 116 forces stripper sleeve 100 longitudinally with respect to extrusion punch 98 so that stripper sleeve 100 contacts the first end 115a of well blank 115 around the perimeter of the well 112 formed therein and strips well blank 115.

Well blank 115 with well 112 is removed from station C and transferred to station D where it is formed into a tubular section 118. At station D, the punch assembly includes hollow punch 120 that is mounted in a tool case 122. Well blank 115 is placed in a die 124 that includes a die insert 126 that is mounted in a sliding die case 128. Sliding die case 128 is mounted in a sliding die sleeve 130 such that die sleeve 130 is secured to the die plate at the die assembly and sliding die case 128 is moveable with respect to die sleeve 130 in the direction of the longitudinal axis of hollow punch 120.

The die assembly at station D further includes a pierce punch 132. The end area 133 of pierce punch 132 substantially corresponds to the shape and area of the bottom of well 112 in well blank 115. Pierce punch 132 is mounted to the die plate and is oriented in alignment with the longitudinal direction of hollow punch 120. A cylindrical kick-out sleeve 134 is concentrically arranged around pierce punch 132 with kick-out sleeve 134 being actuated with respect to pierce punch 132 in the longitudinal direction by an intermediate kick-out pins 136 and a kick-out rod 138.

Sliding die case 128 and die insert 126 are mechanically biased by a spring 140 to the end of travel within die sleeve 130 that is remote from the die assembly. Well blank 115 is mounted in die insert 126 while the die insert 126 is biased against the limit of travel within die sleeve 130 that is away from pierce punch 132. The first end 115a of well blank 115 is then contacted by hollow punch 120 and hollow punch 120 presses against the first end 115a of well blank 115. Hollow punch 120 overcomes the bias force of spring 140 and moves the die insert 126 and well blank 115 toward the end 133 of pierce punch 132.

As hollow punch 120 continues to move well blank 115 along the line of travel within die sleeve 130, the end 133 of pierce punch 132 contacts the second end 115b of well blank 115. As well blank 115 continues to move longitudinally, the end 133 of the pierce punch is received in the hollow punch 120 and pierce punch 132 punches out a portion of the second end 115b of well blank 115 that corresponds to the area of the bottom of the well 112 to form tubular section 118.

The portion of the second end 115b that is cleared is opposite from the bottom of the well 112 such that the pierce punch 132 opens a center bore 142 in the direction of the longitudinal axis of the well blank 115 to form the tubular section 118. Tubular section 118 has an inner cylindrical surface 144 between a first end 146 and a second end 148. Tubular section 118 further includes an outer surface 150 between first end 146 and second end 148. At least a portion of outer surface 150 is tapered such that for a portion of tubular section 118 that is adjacent second end 148, the radial dimension or wall thickness between inner cylindrical surface 144 and outer surface 150 increases as the longitudinal position away from the second end 148 of tubular section 118 increases.

Next, hollow punch 120 is retracted to its initial position and kick-out sleeve 134 is longitudinally actuated by kick-out rod 138 to force the end of the kick-out sleeve 134a against the second end 148 of the tubular section to remove the tubular section from the pierce punch 132 and die insert 126.

Tubular section 118 is then removed from station D, and transferred to station E where it is formed into splined tubular section 165 in which a plurality of spiral splines are formed in the inner surface 144. At station E, the punch assembly includes a punch 150 that is mounted in a tool case 152. Tubular section 118 is placed in a die assembly 154 that includes a die insert 156 that is mounted in a rotating die case 158. Rotating die case 158 is mounted in a sleeve 160 that is mounted to the die plate with a tangent pin 161. Rotating die case 158 is supported on bearings 171 and is moveable angularly with respect to the sleeve 160.

The die assembly at station E further includes a spline punch 162 that has an end with a plurality of spiral splines 164. Spline punch 162 has a substantially constant radius along the length thereof and is mounted to the die plate such that it is oriented in alignment with the longitudinal direction of punch 150. A cylindrical kick-out sleeve 166 is concentrically arranged around spline punch 162 with kick-out sleeve 166 being actuated in the longitudinal direction by an intermediate kick-out pin 168 and a kick-out rod 170.

Rotating die case 158 and die insert 156 are mechanically contained by a pair of bearings 171 to sleeve 160 that is remote from the spline punch 162. Tubular section 118 is mounted in die insert 156. The first end 146 of tubular section 118 is contacted by the punch 150 and as the punch 150 moves tubular section 118 within die insert 156, the end of spline punch 162 contacts the second end 148 of the tubular section 118. As tubular section 118 continues to move longitudinally, the splined end of the spline punch 162 is received in the bore 142 and the spline punch 162 forms spiral splines 163 in the portion of the inner surface 144 of tubular section 118 that is adjacent second end 148. This forms a splined tubular section 165 from tubular section 118.

Spline punch 162 is mounted in the die assembly 154 in a floating manner such that spline punch 162 rotates freely in the angular direction. As spline punch 162 is driven into bore 142, spline punch 162, die insert 156 and rotating die case 158 freely rotate angularly with respect to the longitudinal axis of punch 150 in accordance with the direction of splines 164 to form splines 163 in splined tubular section 165.

When punch 162 has formed splines 163 on inner surface 144 to form splined tubular section 165, punch 150 is retracted to its initial position and kick-out sleeve 166 is longitudinally actuated by kick-out pin 168 and kick-out rod 170 to force the end of the kick-out sleeve against the second end 148 of splined tubular section 165 and remove splined tubular section 165 from the spline punch 162 and die insert 156. Upon removal of the splined tubular section 165, the spline punch 162, die insert 156, and rotating die case 158 angularly rotate with respect to the longitudinal axis of punch 150 in the opposite direction from when the spline punch 162 is driven into bore 142.

At station F, the splined tubular section 165 has spiral splines 163 in one end of the internal surface 144. At station F, the splined tubular section 165 is shaped to provide a splined polygonal section 173 having a hexagonal outer surface 174 and a hexagonal inner surface 176. A punch 178 is secured in a tool case 180. The splined tubular section 165 is placed in a round-to-hexagonal extrusion insert 182 that is mounted in a die case 184. Die case 184 is mounted to the die plate.

After splined tubular section 165 is transferred to extrusion insert 182, punch 178 contacts first end 146 of splined tubular section 165 to force splined tubular section 165 through extrusion insert 182. The movement of splined tubular section 165 through extrusion insert 182 shapes the tapered outer surface 150 of splined tubular section 165 to a hexagonal outside surface 174 of splined polygonal section 173. That is, in a cross-section of splined polygonal section 173 that is orthogonal to longitudinal center axis 15, surface 174 defines a hexagonal shape. At the same time, the extrusion forms the cylindrical inner surface 144 of the splined tubular section 165 into a hexagonal inner surface 176 of splined polygonal section 173. That is, in a cross-section of splined polygonal section 173 that is orthogonal to longitudinal center axis 15, surface 176 defines a hexagonal shape. The shape of inner surface 176 is tapered throughout the longitudinal length of the portion of the splined polygonal section 173 that is adjacent to the second end 148 of the splined polygonal section 173 such that radial thickness or wall thickness between inner surface 176 and outer surface 174 increases as the longitudinal position away from the second end 148 of the splined polygonal section 173 increases. The shape of hexagonal inner surface 176 is substantially constant throughout the portion of splined polygonal section 173 that is adjacent to second end 184. However, the area enclosed by surface 176 progressively decreases and the hexagonal sides also decrease as the longitudinal position away from the second end 148 of section 173 increases. Splines 163 in the portion of section 173 that is adjacent to the second end 148 are spiraled and otherwise arranged as previously described herein with respect to tool 10.

After the cold-forming steps described in connection with FIGS. 3A-3F and 4A-4F have been completed, the outer surface 174 of splined polygonal section 173 is machined and finished to provide the outer surface of the portion of the tool that is adjacent to the second end 148 with a round surface. The outer surface can be finished with conventional finishing processes as well known and understood by those skilled in the relevant art.

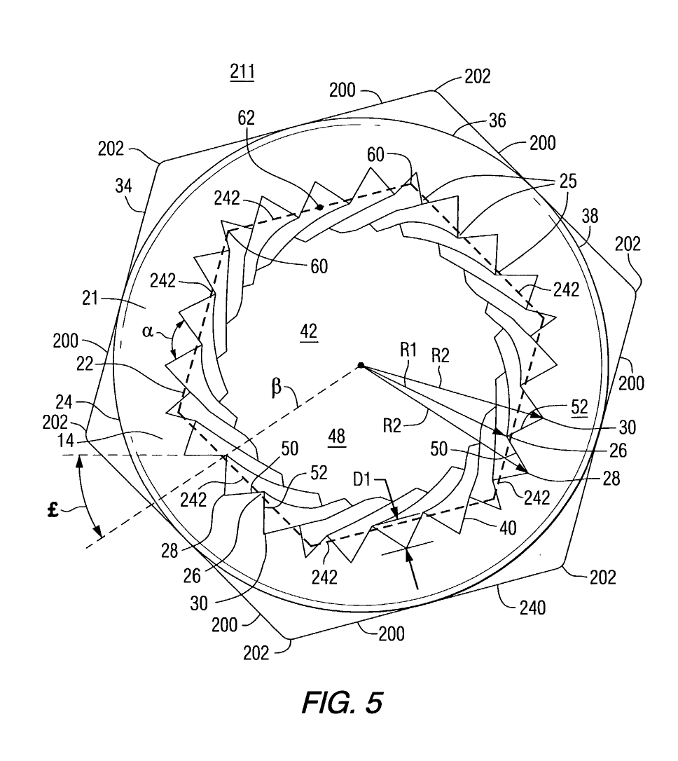

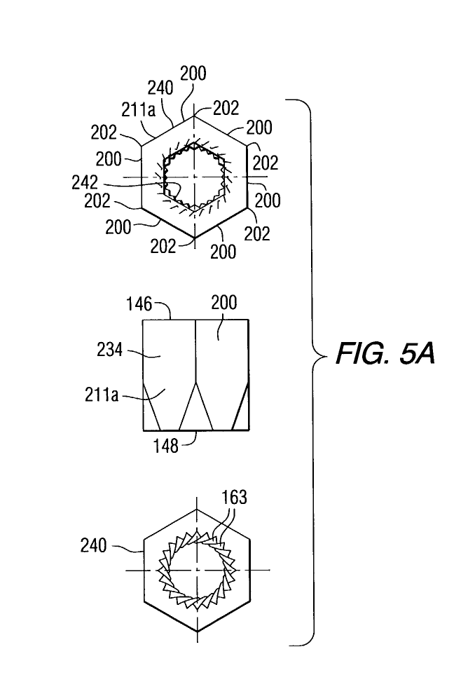

FIG. 5 shows an improved embodiment of the tool 10 that is previously described herein in connection with FIGS. 1 and 2 wherein like features of the tool 211 shown in FIG. 5 have corresponding reference characters. It has been found that it would be preferable for the polygonal or hexagonal surface portion 34 of outside surface 32 to meet industry standards that are applicable to polygonal or hexagonal threaded fasteners. To meet such standards, the sides 200 of the polygonal surface 34 must join at an edge that is radiused within stated tolerances. In the tool 211 shown in FIG. 5, sides 200 that are adjacent to each other cooperate to define radiused edges 202. Radiused edges 202 are in contrast to the beveled surfaces 204 that join the sides of the polygonal surface 34 in the tool that is shown in FIGS. 1 and 2. Radiused edges 202 allow the tool 211 shown in FIG. 5 to meet the specifications that are applicable to threaded fasteners and provide a tool that is serviceable under higher applied torque pressure without destruction of the polygonal surface 34.

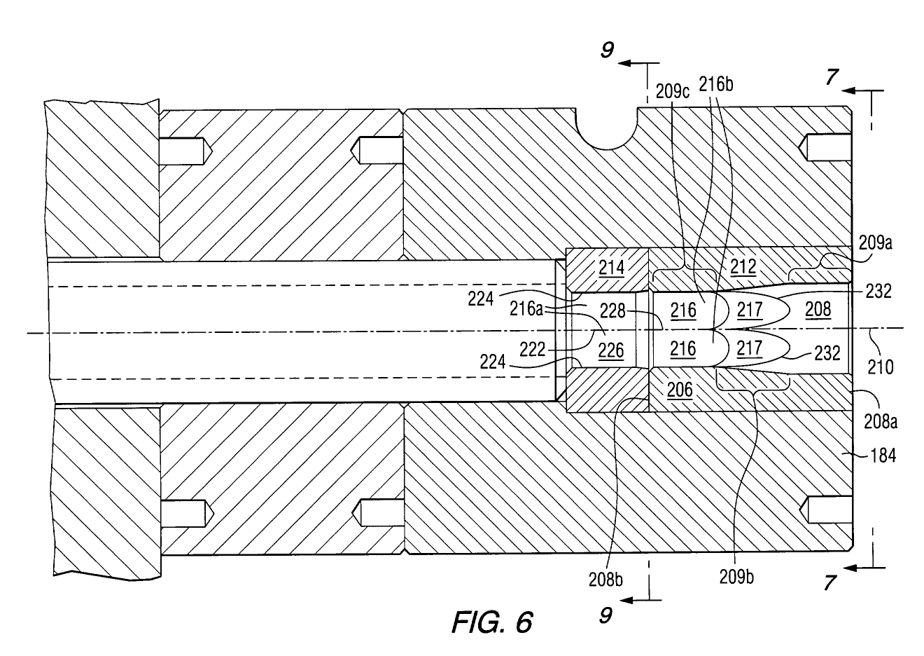

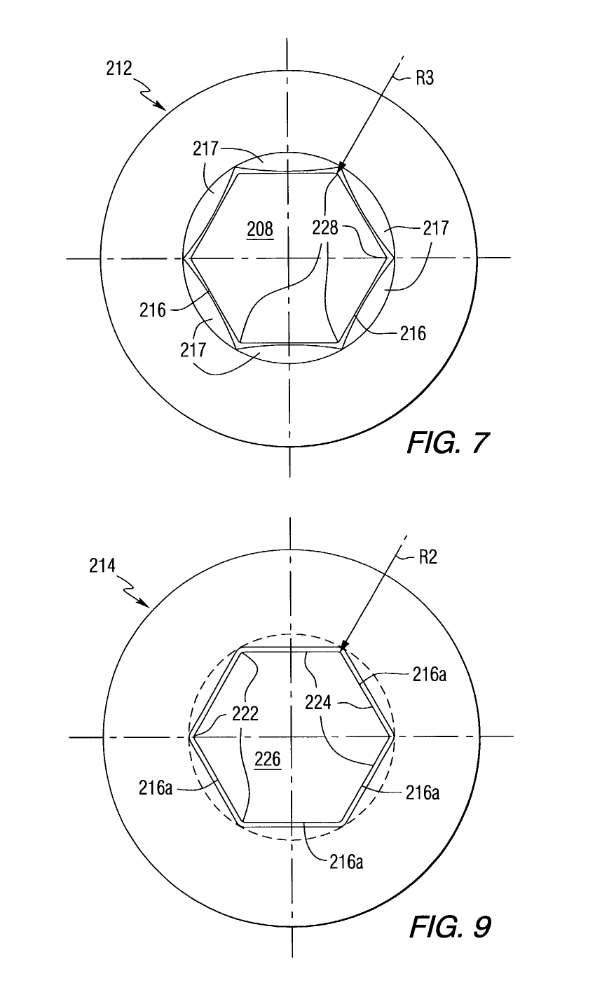

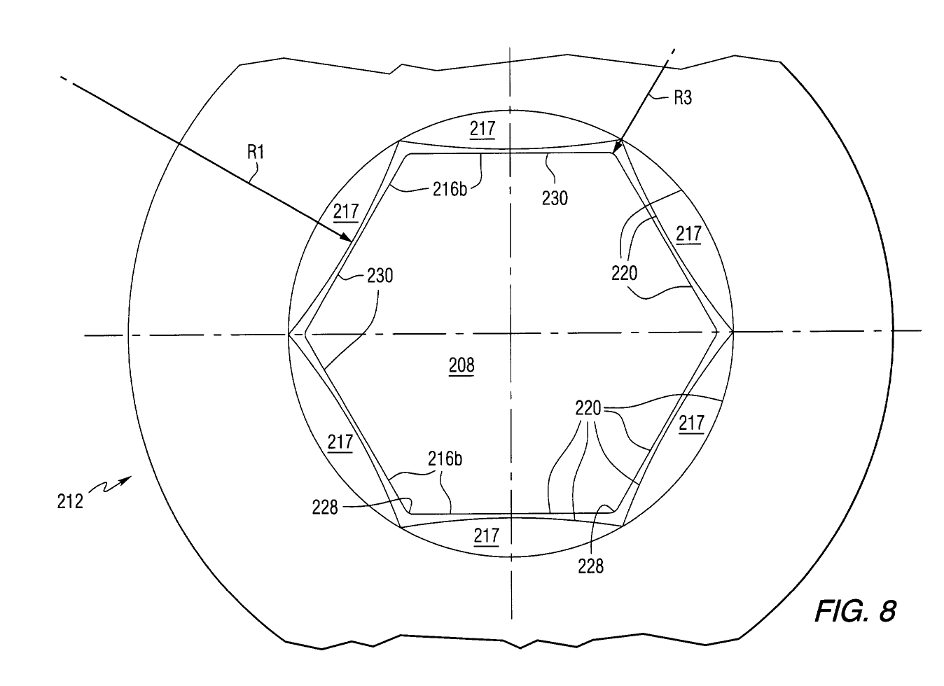

A presently preferred method for making the tool shown in FIG. 5 is described in connection with FIGS. 3A through 3E and FIG. 5A. To produce the splined polygonal section 211a shown in FIG. 5A, the round-to-polygonal extrusion die insert 182 that is shown in FIG. 3F is replaced by the round-to-polygonal die insert 206 that is shown in FIGS. 6-9. Round-to-polygonal die insert 206 defines an inner passageway 208 along a longitudinal center axis 210 between an entry end 208a and an exit end 208b. Round-to-polygonal die insert 206 includes a first portion 212 that is further described in connection with FIGS. 7 and 8 and also includes a second portion 214 that is further described in connection with FIG. 9.

As more particularly shown in FIGS. 7 and 8, the first section 212 of die insert 206 defines an internal passageway 209 that forms a section of passageway 208. Internal passageway 209 includes a first portion 209a that is in the general shape of circular cylinder, a second portion 209b that longitudinally joins portion 209a. Second portion 209b is in the general shape of a circular frustum with the major end joining one end of the circular cylinder portion 209a. Second portion 209b further defines a plurality of internal surfaces 217 that are superimposed on the circular frustum of portion 209b. Internal surfaces 217 are generally bowed in a radially inward direction toward longitudinal center axis 210 such that a cross-section of an integral surface 217 taken orthogonally with respect to longitudinal axis 210 defines a chord surface that is bowed radially inwardly along a constant radius of curvation. The shape of internal surfaces is such that the length of the chord surface intersecting an orthogonal cross-section increases as the longitudinal distances from entry and 208a and the first portion 209a also increase until the chords touch end-to-end.

Internal passageway 209 further includes a third portion 209c that defines a polygonal sided cylinder that is a hexagonal cylinder in the preferred embodiment of FIGS. 6-8. The third portion 209c longitudinally joins the minor end of the circular frustum of portion 209b with internal surfaces 217 superimposed thereon. The number of internal surfaces 217 corresponds to the number of sides 216 of polygonal portion 209c-in the embodiment of FIGS. 6-8—this is six sides.

In portion 209c, the number of sides 216 corresponds to the desired number of sides 200 for the polygonal surface 34 of the finished tool. In the example of the presently preferred embodiment, polygonal surface 234 has six sides 200 and first section 212 of die insert 206 also has six sides 216. Sides 216 of first section 212 that are adjacent to each other are joined together at radiused joints 228. Thus, third portion 209c with sides 216, second portion 209b with surfaces 217, and first portion 209a cooperate to define an inner surface 220 of first section 212 of die insert 206.

As particularly shown in FIGS. 6, 7 and 8, first portion 212 has a converging tapered portion 209b with inwardly bowed surfaces 217 such that passageway 208 converges toward the longitudinal center axis 210 at longitudinal positions moving in the direction from input or entry end 208a to exit or output end 208b of die insert 206. In addition, tapered portions 217 of internal passageway 209 are bowed inwardly in a radial direction toward the longitudinal center axis 210. As more particularly shown in FIG. 8, tapered portions 217 are bowed inwardly in a continuous radius of curvature that is defined according to a constant radius R1.

As particularly shown in FIGS. 6, 7 and 8 of the presently preferred embodiment, in addition to tapered portion 217, each of sides 216 of the first portion of 212 of die insert 206 also include a portion 216b in which sides 216 are planar. Side portions 216b that are adjacent to each other are joined together and along radiused joints 228. Side portions 216b cooperate collectively to define an inner surface 230 of the first portion 212 of die insert 206. Side portions 216b also cooperate with tapered side portions 217 to define an inner passageway 208. The portion of inner passageway 208 that is defined by sides 216b has a substantially constant cross-section at positions along the longitudinal axis 210 of die insert 206.

As also shown in FIGS. 7 and 8, the radiused joints 228 of side portions 206b are defined by the tangent to a constant inner radius of curvature having a radius R3. The radial distance between the radiused joint of sides 216b and longitudinal center axis 210 is less than the radial distance between the tapered side portions 217 and the longitudinal center axis 210 at the same angular position. In this way, the material of the splined polygonal section 211a tends to be cold formed into the areas located between the boundaries 232 of the tapered portions 217 as the splined polygonal section 211a is extruded. As the splined tubular section 165 passes through the tapered portion 209b of the die insert, the sides 216b compress the material into corners that are defined according to the shape of the corners formed by surfaces 216b.

As also shown in FIGS. 6 and 9, second portion 214 of die insert 206 has sides 216a. The number of sides 216a corresponds to the respective number of sides 216 in first portion 212. In contrast to portions 217 which are bowed inwardly as further shown and described in connection with FIGS. 7 and 8, sides 216a are planar. Sides 216a that are adjacent to each other are joined along junctions 222. Sides 216a of second portion 214 cooperate to define an inner surface 224 of the second portion 214 of die insert 206. At least a portion of the internal sides 216a define an inner passageway 226. Inner passageway 226 has a substantially constant cross-section at positions along the longitudinal axis 210 of die insert 206. As also shown in FIGS. 6 and 9, the junctions 222 of sides 206a are defined by the tangent of a constant inner radius of curvature having a radius R2. In accordance with the preferred embodiment, in the plane orthogonal to the longitudinal center axis 210, the dimensions of sides 216a and of inner radius of curvature R2 are equivalent to the corresponding standard dimensions of a selected threaded fastener.

Referring to the disclosed method for making the tool shown in FIG. 5, the methods are essentially the same as those steps described in connection with FIGS. 3-A to 3-E. Upon reaching the next station, station F, the splined tubular section 165 has spiral splines 163 in one end of the internal surface 144. For the tool shown in FIG. 5, at station F the splined tubular section 165 is formed to provide a hexagonal outer surface 240 and a hexagonal inner surface 242 as shown in FIG. 5A. A punch 178 is secured in a tool case 180. The splined tubular section 165 is placed in round-to-hexagonal extrusion insert 206 that is mounted in a die case 184. Die case 184 is mounted to the die plate.

After splined tubular section 165 is transferred to extrusion insert 206, punch 178 contacts first end 146 of splined tubular section 165 to force splined tubular section 165 through extrusion insert 206. The movement of splined tubular section 165 through extrusion insert 206 forms splined polygonal section 211a by cold forming the tapered outer surface 150 of splined tubular section 165 to a surface 240 that is a hexagonal surface. That is, in a cross-section of splined polygonal section 211 a that is orthogonal to longitudinal center axis 210, surface 240 defines a hexagonal shape that corresponds to the shape of the second portion 214 of the die insert 206.

At the same time, the extrusion cold forms the cylindrical inner surface 144 of the tubular section into a hexagonal inner surface 242. That is, in a cross-section of splined polygonal section 211a that is orthogonal to longitudinal center axis 210, surface 242 defines a generally hexagonal shape. The shape of inner surface 242 is tapered throughout the longitudinal length of the portion of the splined polygonal section 211a that is adjacent to the second end 148 of the splined polygonal section 211a such that the radial dimension or wall thickness between inner surface 242 and outer surface 240 increases as the longitudinal position away from the second end 148 of the splined polygonal section 211a increases. The shape of inner surface 242 is substantially constant throughout the portion of section 211a that is adjacent to second end 148. However, the area enclosed by surface 242 progressively decreases and the width of hexagonal sides also decreases as the longitudinal position away from the second end 148 of the section 211a increases. Splines 163 in the portion of the section 211a that is adjacent to the second end 148 are spiraled and otherwise arranged as previously described herein with respect to tool 10.

After the cold-forming steps described in connection with FIGS. 3A-3F, 4A-4F, and 5-9 have been completed, the outer surface of the splined polygonal section 21 a is machined and finished to provide the outer surface of the portion of the tool 10 that is adjacent to the second end 148 with a round surface. The outer surface can also be finished with conventional finishing processes as well known and understood by those skilled in the relevant art.

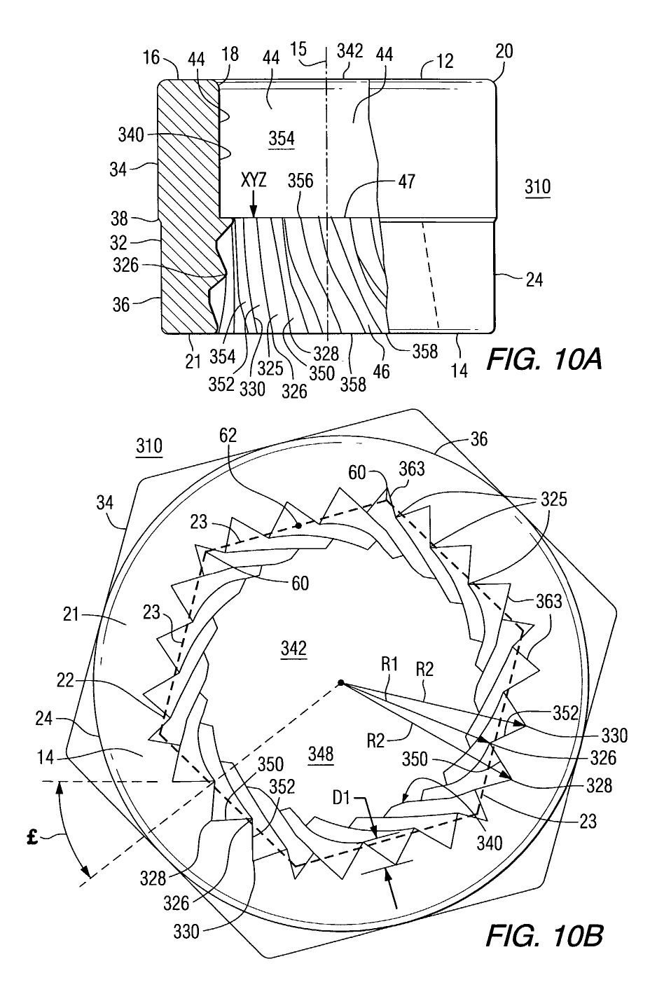

A tool for securing tamper resistant fasteners is shown and described in connection with FIGS. 10A and 10B. FIGS. 10A and 10B show a tool 310 that is similar to the tool shown in FIG. 5, for which similar structures are assigned corresponding reference characters.

As shown in FIGS. 10A and 10B, tool 310 is useful for securing tamper-resistant fasteners of the type that have a smooth cylindrical outer surface such that the fastener cannot be gripped by conventional wrenches. Instead the fastener requires the use of a special tool that can engage the smooth, rounded outer surface of the fastener.

Similar to tool 10, tool 310 includes a first end 12 and a second end 14 that are aligned on a longitudinal center axis 15. Other parts of tool 310 are as described with respect to the tool of FIG. 5 except that hexagonal inner edge 22 includes a plurality of splines 325. Splines 325 are directed radially inwardly towards the longitudinal center axis 15 of tool 310, but splines 325 are oriented in the opposite sense from splines 25 of the tool of FIG. 5. Specifically, splines 325 are oriented in a left-hand spiral whereas the splines 25 of the tool of FIG. 5 are oriented in a right-hand spiral. Each of splines 325 are defined by a respective crest 326 that is located at a first radial position from the longitudinal center axis 15 and two roots 328, 330 that are angularly located on opposite sides of crest 326. The radial position R2 of each of said roots 328, 330 from the longitudinal center axis 15 is greater than the radial position of R1 the crest 326.

An inside surface 340 between first end 12 and second end 14 defines a closed passageway 342 between the first and second ends. Inside surface 340 defines a hexagonal surface wherein inside surface 340 defines a generally hexagonal shape in a plane that is orthogonal to axis 15. More specifically, inside surface 340 defines a central opening 348 wherein the cross-sectional area of the central opening taken orthogonally to longitudinal center axis 15 decreases as the longitudinal spacing from second end 14 increases. Accordingly, inside surface 340 defines a hexagonal frustum 354 having a minor end 356 that is located at the transitional boundary 47 and a major end 358 that is located at the second end 14 of tool 310.

As also shown in FIGS. 10A and 10B, splines 325 have a spiral shape and extend substantially throughout inside surface 340 of tool 310. As previously explained, splines 325 are defined by a crest 326 and roots 328, 330 that are disposed on opposite sides of crest 326. At any given position along longitudinal center axis 15, the radial position of roots 328, 330 from the longitudinal center axis are greater than the radial position of the crest 326.

The depth D1 of spline 325 is defined as the difference between R1, the radial position of crest 328, and R2, the radial position of roots 328 and 330, at a given location on the longitudinal center axis 15. In accordance with the presently disclosed invention, the depth D1 of the spline 325 is substantially constant at all longitudinal positions of the spline between end 356 (at transitional boundary 47) and end 358.

For each spline 325, crest 326 cooperates with each of roots 328, 330 to define sides 350 and 352 respectively at a given longitudinal position defined by a plane that is orthogonal to the longitudinal center axis 15. Each of sides 350 and 352 define an internal included angle. The angle between the bisector of the internal included angle and either side 350 or 352 defines the relief angle £ of the spline at that longitudinal position. As shown in FIGS. 1 and 2, the relief angle £ for each of splines 325 progressively decreases as the longitudinal position changes in the direction toward the minor end 356 of hexagonal frustum 354. Conversely, the relief angle £ for each of splines 325 progressively increases as the longitudinal position moves in the direction toward the major end 358 of hexagonal frustum 354.

Viewed from the end 14 of tool 310, each of spines 325 have a generally triangular cross-section wherein sides 350 and 352 converge to form an apical edge or crest 326. The radial position of said splines 325 with respect to the longitudinal center axis 15 decreases as the angular position of the crest 326 of said spline approaches the angular position of the midpoint 62 of the hexagonal side 23. In this way, even though the depth of each of the splines 325 is substantially the same, the splines that are closest to the respective midpoints 62 of hexagonal sides 23 are located at a shorter radial distance from the longitudinal center axis 15 than splines 325 that are located further away from the respective midpoints 62 of hexagonal sides 23.

In the use of tool 310, the tool is placed over a tamper-resistant fastener that is to be secured. The tool 310 is positioned on the fastener such that the second end 14 of tool 310 passes over the outside perimeter of the fastener and splines 325 in the hexagonal frustum 354 engage the fastener.

The hexagonal shape of inside surface 340 affords improved operation of the disclosed tool in comparison to other tools known in the prior art. The splines 325 that are closest to the midpoint 62 of the hexagonal sides 23 engage the fastener while the splines 325 that are located away from midpoint 62 of the hexagonal sides 23 are held away from the fastener. That is because the midpoint 62 of the hexagonal sides is at a shorter radius from the longitudinal center axis 15 of the tool 310 than the corners 60. The splines 325 that are closest to the midpoint 62 engage the fastener before the splines that are located closer to corners 60.

When torque is applied to the tool 310 through a wrench or other lever (not shown) that is placed over portion 34 of outside surface 32 this arrangement provides for transfer of the torque to the fastener through less than all of the splines 325. This causes the splines 325 that do engage the fastener to bite into the fastener more deeply than arrangements wherein all of the splines initially engage the fastener. It has been found that this arrangement results in deeper engagement of the splines into the fastener and allows greater torque to be applied to the fastener.

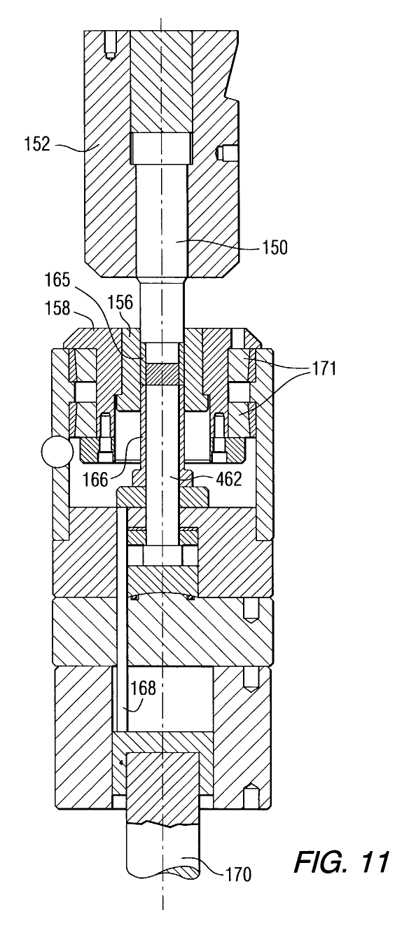

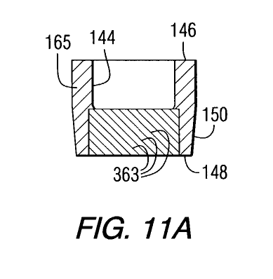

The tool 310 that is shown and described in connection with FIGS. 10A and 10B can be made according to the process for making the tool 10 of FIGS. 1 and 2 and tool 211 of FIG. 5. That process is substantially as shown and described in connection with FIGS. 3A-3F, 4A-4F, and 6-9 except that the spline punch 162 that is therein described for the method for making tools 10 and 211 is replaced with a spline punch 462 as illustrated in FIG. 11. The spline punch 462 shown in FIG. 11 is similar to the spline punch 162 as shown and described in connection with FIG. 3E except that the splines on punch 462 have a clockwise orientation whereas the splines on punch 162 have a counter-clockwise orientation. In other respects, spline punch 462 operates substantially the same as spline punch 162.

When punch 462 has formed splines 363 on inner surface 144 of splined tubular section 165 (as shown in FIG. 11A), punch 150 is retracted to its initial position and kick-out sleeve 166 is longitudinally actuated by kick-out pin 168 and kick-out rod 170 to force the end of the kick-out sleeve against the second end 148 of the splined tubular section and remove the splined tubular section from the spline punch 462 and die insert 156. Upon removal of the splined tubular section 165, the spline punch 462 rotates in the opposite angular direction from the rotation when the spline punch 462 is driven into bore 142.

The clockwise orientation of the splines of punch 462 causes the splines that are formed on the inner surface of the splined tubular section 165 to also have a clockwise orientation. In the finished tool 310, this results in the splines 325 having the clockwise orientation as shown in FIGS. 10A and 10B.

While several presently preferred embodiments of the disclosed tool, together with several presently preferred methods for making the same, have been disclosed herein, the scope of the disclosed invention is not limited thereto, but can otherwise be variously embodied within the scope of the following claims.

What is claimed is:

1. A process for making a tool for removing fasteners wherein the tool is cold formed from a tubular section that has a cylindrical inside surface and a tapered outside surface, said process comprising:
driving the tubular section onto a floating punch that has helical splines at one end, said floating punch rotating in a first angular direction as the tubular section is driven onto the floating punch to form a splined tubular section that has a tapered outside surface and a cylindrical inside surface having helical splines in one end of the cylindrical inside surface;
stripping the splined tubular section off of the end of the floating punch, said floating punch rotating in the opposite angular direction from the first direction as the splined tubular section is stripped off of the floating punch; and
extruding the splined tubular section through a round-to-polygonal extrusion die insert to cold form the splined tubular section having a tapered outside surface and a cylindrical inside surface to a splined polygonal section that has a polygonal outside surface and a tapered, polygonal inside surface that includes a plurality of spiral splines, wherein the tapered outside surface of the splined tubular section is cold formed to the polygonal outside surface of the splined polygonal section with adjoining sides of the polygonal outside surface cooperating to define an edge and said polygonal outside surface defining a substantially constant cross-section, and also wherein said cylindrical inside surface of said splined tubular section is cold formed to the tapered, polygonal inside surface of the splined polygonal section.

2. The process of claim 1 wherein said extruding step further includes extruding the splined tubular section through a round-to-polygonal extrusion die insert that has a plurality of internal surfaces that are bowed in a radially inward direction, said bowed internal surfaces cooperating to define a converging taper in the direction of extrusion of the splined tubular section.

3. The process of claim 2 wherein the internal surfaces are inwardly bowed along a substantially constant radius.

4. The process of claim 3 wherein the internal surfaces are inwardly bowed according to a predetermined radius-of-curvature.

5. The process of claim 2 wherein said round-to-polygonal extrusion die insert defines an inner passageway along a longitudinal axis and wherein the round-to-polygonal extrusion die insert includes:
a first portion that has a plurality of internal surfaces that are bowed in a radially inward direction, said radially bowed internal surfaces cooperating to define at least a portion of the inner passageway of the first portion of the extrusion die insert, said plurality of radially bowed internal surfaces having a radially inward taper that converges in the direction of extrusion of the splined tubular section, said plurality of radially bowed internal surfaces being arranged at regular angular locations, and
a second portion that has a plurality of internal sides that cooperate to define the inner surface of the second portion of the die insert, the plurality of internal sides of the second portion of the die insert defining an inner passageway having a substantially constant cross-section at positions along the longitudinal axis of the die insert.

6. The process of claim 5 wherein the junction of the internal sides of the second portion of the round-to-polygonal extrusion die insert define a radiused joint.

7. A process for cold forming a tool for removing fasteners, said tool being cold formed from a tubular section that has a first end and a second end with an open passageway between the first and second ends, said tubular section defining a cylindrical inner surface along a longitudinal axis between said first and second ends, said tubular section also defining a tapered outer surface that has an increasing diameter at longitudinal positions on the tubular section that are increasingly apart from the second end of the tubular section, said cold forming process comprising:
driving a punch against the first end of the tubular section to place the tubular section into a die insert that is mounted in a die sleeve, said die insert being moveable with respect to said die sleeve in a direction that is angular with respect to the longitudinal axis, the second end of said tubular section being driven onto a floating punch having helical splines that are located at the distal end thereof, said floating punch rotating with respect to said die insert in a first angular direction as the tubular section is driven onto the floating punch and the splines form complementary internal splines on the cylindrical inner surface of the tubular section to form a splined tubular section that has a tapered out side surface and a cylindrical inside surface between fist and second ends;
stripping the splined tubular section off of the floating punch by pushing against the second end of the splined tubular section with a stripper sleeve, said floating punch counter-rotating with respect to said die insert in the opposite angular direction from said first angular direction as the stripper sleeve presses on the second end of the splined tubular section and the splined tubular section travels to the end of the spline punch;
extruding the splined tubular section through a round-to-polygonal extrusion die insert to cold form a splined polygonal section that has a polygonal outside surface and a tapered polygonal inside surface that are located between first and second ends, said extruding step cold forming the tapered outside surface of the splined tubular section into the polygonal outside surface of the splined polygonal section, said polygonal outside surface having adjoining sides that cooperate to define an edge, said polygonal outer surface having a substantially constant cross-sectional area at longitudinal positions between said first and second ends of the splined polygonal section, said extruding step also cold forming the inner surface of the splined tubular section into the tapered, polygonal inside surface of the splined polygonal section, the shape of said tapered inside polygonal surface corresponding to the shape of said polygonal outside surface, said inside polygonal surface being tapered to provide a decreasing cross-sectional area at longitudinal positions in the direction from the second end of the splined polygonal section toward the first end of the splined polygonal section to provide an inner surface having a tapered, polygonal shape with helical splines in the end of said inner surface that is adjacent to the second end.

8. The process of claim 7 wherein said extruding step further includes extruding the splined tubular section through a round-to-polygonal extrusion die insert that has a plurality of internal surfaces that are bowed in a radially inward direction, said bowed internal surfaces cooperating to define a converging taper in the direction of extrusion of the splined tubular section.

9. The process of claim 8 wherein the internal surfaces are inwardly bowed along a substantially constant radius.

10. The process of claim 9 wherein said round-to-polygonal extrusion die insert defines an inner passageway along a longitudinal axis between an entry end and an exit end, said round-to-polygonal extrusion die insert including:
a first portion that has an inner surface that defines a part of said inner passageway, said inner surface of said first portion defining a circular cone together with a plurality of internal sides, said circular cone converging in the direction from the entry end to the exit end of the extrusion die insert, said circular cone having superimposed thereon a plurality of surfaces that bow radially inwardly; and
a second portion that has a plurality of internal surfaces that cooperate to define the second portion of the passageway of said round-to-polygonal extrusion die insert, the internal surfaces of the second portion of the die insert having a substantially constant cross-section at positions along the longitudinal axis of the die insert.

11. The process of claim 10 wherein internal surfaces of the second portion of the extrusion die insert meet to form a radiused joint.

12. A tool for removing fasteners, said tool being made according to the process wherein the tool is cold formed from a tubular section that has a cylindrical inside surface and a tapered outside surface, said process comprising the steps of:
driving the tubular section onto a floating punch that has helical splines at one end, said floating punch rotating in a first angular direction as the tubular section is driven onto the floating punch to form a splined tubular section that has a tapered outside surface and a cylindrical inside surface having helical splines in one end of the cylindrical inside surface;
stripping the splined tubular section off of the end of the floating punch, said floating punch rotating in the opposite angular direction from the first direction as the splined tubular section is stripped off of the floating punch; and
extruding the splined tubular section through a round-to-polygonal extrusion die insert to cold form the splined tubular section having a tapered outside surface and a cylindrical inside surface to a splined polygonal section that has a polygonal outside surface and a tapered, polygonal inside surface that includes a plurality of spiral splines, wherein the tapered outside surface of the splined tubular section is cold formed to the polygonal outside surface of the splined polygonal section with adjoining sides of the polygonal outside surface cooperating to define an edge and said polygonal outside surface defining a substantially constant cross-section, and also wherein said cylindrical inside surface of said splined tubular section is cold formed to the tapered, polygonal inside surface of the splined polygonal section.

13. A tool made according to the process of claim 12 wherein said extruding step further includes extruding the splined tubular section through a round-to-polygonal extrusion die insert that has a plurality of internal surfaces that are bowed in a radially inward direction, said bowed internal surfaces cooperating to define a converging taper in the direction of extrusion of the splined tubular section. extruding the tubular section through a round-to-polygonal extrusion die insert that has a plurality of internal sides each of said internal sides joining with the adjacent internal sides such that said sides cooperate to define the inner surface of the die insert, at least a portion of said plurality of internal sides defining a converging taper in the direction of extrusion of the tubular section, said plurality of internal sides also bowing in a radially inward direction of angular positions of the internal side.

14. A tool made according to the process of claim 13 wherein the internal surfaces are inwardly bowed along a substantially constant radius.

15. A tool made according to the process of claim 14 wherein the internal surfaces are inwardly bowed according to a predetermined radius-of-curvature.

16 A tool made according to the process of claim 13 wherein said round-to-polygonal extrusion die insert defines an inner passageway along a longitudinal axis and wherein the round-to-polygonal extrusion die insert includes:
a first portion that has a plurality of internal surfaces that are bowed in a radially inward direction, said radially bowed internal surfaces cooperating to define at least a portion of the inner passageway of the first portion of the extrusion die insert, said plurality of radially bowed internal surfaces having a radially inward taper that converges in the direction of extrusion of the splined tubular section, said plurality of radially bowed internal surfaces being arranged at regular angular locations, and
a second portion that has a plurality of internal sides that cooperate to define the inner surface of the second portion of the die insert, the plurality of internal sides of the second portion of the die insert defining an inner passageway having a substantially constant cross-section at positions along the longitudinal axis of the die insert.

17. A tool made according to the process of claim 16 wherein the junction of the internal sides of the second portion of the round-to-polygonal extrusion die insert define a radiused joint.

18. A tool for removing fasteners, said tool being made according to the process wherein the tool is cold formed from a tubular section that has a first end and a second end with an open passageway between the first and second ends, said tubular section defining a cylindrical inner surface along a longitudinal axis between said first and second ends, said tubular section also defining a tapered outer surface that has an increasing diameter at longitudinal positions on the tubular section that are increasingly apart from the second end of the tubular section, said cold forming process comprising:
driving a punch against the first end of the tubular section to place the tubular section into a die insert that is mounted in a die sleeve, said die insert being moveable with respect to said die sleeve in a direction that is angular with respect to the longitudinal axis, the second end of said tubular section being driven onto a floating punch having helical splines that are located at the distal end thereof, said floating punch rotating with respect to said die insert in a first angular direction as the tubular section is driven onto the floating punch and the splines form complementary internal splines on the cylindrical inner surface of the tubular section to form a splined tubular section that has a tapered out side surface and a cylindrical inside surface between first and second ends;
stripping the splined tubular section off of the floating punch by pushing against the second end of the splined tubular section with a stripper sleeve, said floating punch counter-rotating with respect to said die insert in the opposite angular direction from said first angular direction as the stripper sleeve presses on the second end of the splined tubular section and the splined tubular section travels to the end of the spline punch;
extruding the splined tubular section through a round-to-polygonal extrusion die insert to cold form a splined polygonal section that has a polygonal outside surface and a tapered polygonal inside surface that are located between first and second ends, said extruding step cold forming the tapered outside surface of the splined tubular section into the polygonal outside surface of the splined polygonal section, said polygonal outside surface having adjoining sides that cooperate to define an edge, said polygonal outer surface having a substantially constant cross-sectional area at longitudinal positions between said first and second ends of the splined polygonal section, said extruding step also cold forming the inner surface of the splined tubular section into the tapered, polygonal inside surface of the splined polygonal section, the shape of said tapered inside polygonal surface corresponding to the shape of said polygonal outside surface, said inside polygonal surface being tapered to provide a decreasing cross-sectional area at longitudinal positions in the direction from the second end of the splined polygonal section toward the first end of the splined polygonal section to provide an inner surface having a tapered, polygonal shape with helical splines in the end of said inner surface that is adjacent to the second end.

19. A tool made according to the process of claim 18 wherein said extruding step further includes extruding the tubular section through a round-to-polygonal extrusion die insert that has a plurality of internal surfaces that are bowed in a radially inward direction, said bowed internal surfaces cooperating to define a converging taper in the direction of extrusion of the splined tubular section.

20. A tool made according to the process of claim 19 wherein the internal surfaces are inwardly bowed along a substantially constant radius.

21. A tool made according to the process of claim 19 wherein said round-to-polygonal extrusion die insert defines an inner passageway along a longitudinal axis and wherein the round-to-polygonal extrusion die insert includes:
a first portion that has a plurality of internal surfaces that are bowed in a radially inward direction, said radially bowed internal surfaces cooperating to define at least a portion of the inner passageway of the first portion of the extrusion die insert, said plurality of radially bowed internal surfaces having a radially inward taper that converges in the direction of extrusion of the splined tubular section, said plurality of radially bowed internal surfaces being arranged at regular angular locations, and
a second portion that has a plurality of internal sides that cooperate to define the inner surface of the second portion of the die insert, the plurality of internal sides of the second portion of the die insert defining an inner passageway having a substantially constant cross-section at positions along the longitudinal axis of the die insert.

22. A tool made according to the process of claim 21 wherein the junction of the internal sides of the second portion of the round-to-polygonal extrusion die insert define a radiused joint.

23. A tool for removing fasteners, said tool being made according to the process wherein the tool is cold formed from a cutoff blank that is cut from a wire line, said process comprising:
hitting the cutoff blank to square up the blank and to form a tapered blank having a tapered outside surface;
punching the tapered blank with an extrusion punch to form an extruded, blank having first and second ends and having a well formed, said well being formed by extruding metal in the tapered blank in the direction past the extrusion punch, said well being on the same side of the tapered blank as the extrusion punch;
urging a hollow punch against the first end of the extruded blank to maintain the extruded blank in a die insert, said die insert being slidably mounted in a die sleeve and mechanically biased toward one end of the die sleeve, said hollow punch urging the blank into the die insert and pushing the second end of the extruded blank against a pierce punch, the second end of said extruded, blank being located oppositely from the bottom of the well in said extruded blank, said second end of said extruded blank being pressed against the pierce punch to form a tubular section by piercing the second end of the extruded blank, said tubular section having a tapered outside surface and a cylindrical inside surface between first and second ends;
pushing on the first end of the tubular section when the tubular section is mounted in a die insert that is rotatably mounted in a die sleeve, said pushing step moving the tubular section onto a floating punch that has helical splines at the end thereof to form a splined tubular section having a tapered outer surface and a cylindrical inner surface with helical splines in a portion of the inside surface adjacent to the second end of the splined tubular section, said floating punch rotating in a first direction and said helical splines interfering with the inside surface of the tubular section as the tubular section is moved onto the floating punch to form internal helical splines in the portion of said cylindrical inner surfaces;
relieving the force against the first end of the splined tubular section;
urging a kickout sleeve against the second end of the splined tubular section to strip the splined tubular section off of the splined end of the floating punch while the floating punch rotates in the direction that is the opposite direction from the first direction of rotation; and
extruding the splined tubular section through a round-to-hexagonal extrusion die to form a polygonal splined section having a polygonal outer surface and a tapered polygonal inner surface between first and second end, the tapered outer surface of the splined tubular section being cold formed to the polygonal outer surface of the splined polygonal section, said polygonal outer surface having a cross-section with substantially constant dimensions at positions along the longitudinal axis of the splined polygonal section, and the inside cylindrical surface of the splined tubular section being cold formed to a polygonal cross-section with smaller dimensions at longitudinal positions away from the second end of the splined polygonal section, the inner surface also having spiral-shaped splines in a portion of the inner surface that is adjacent to the second end of the splined polygonal section.

24. A tool for securing tamper-resistant fasteners of the type having a rounded outer surface, said tool comprising:
a first end;
a second end that is oppositely disposed on the tool body from the first end;
an outside surface that is defined between the first and second ends; and
an inside surface that defines a closed passageway between the first and second ends, a portion of the inside surface adjacent to said second end having a generally polygonal cross-section, the portion of said inside surface adjacent to said second end defining a central opening with the area of said central opening decreasing as the longitudinal position away from the second end increases, said polygonal, internal surface adjacent to said second end further including a plurality of inwardly extending spiral splines that are oriented on said internal surface in a clockwise sense.

25. The tool of claim 24 wherein each of said spiral splines extend substantially through the portion of said inside surface that is adjacent to said second end.

26. The tool of claim 25 wherein each of said spiral splines have a generally triangular cross-section with two lateral sides that coverage at an apical edge, said apical edge forming the radially innermost extending portion of the spiral spline.

27. The tool of claim 26 wherein adjacent polygonal sides of the portion of said inside surface that is adjacent to said second end are joined by corners and each of the polygonal sides has a respective midpoint that is located midway between the corners on each end of a polygonal side, and wherein said splines extend radially inwardly, the radial inward extent of said splines being greater for splines where the angular location of the apical edge of said spline is closer to the angular location of the midpoint of said polygonal side.

28. The tool of claim 27 wherein the radial inward extent of said splines is smaller for splines where the angular location of the apical edge of said spline is farther from the angular location of the midpoint of said polygonal side.

29. The tool of claim 27 wherein the radial location of the apical edge of said splines is defined by the radial distance of said edge from the longitudinal center axis of the tool.

30. The tool of claim 29 wherein the maximum radial location of the apical edge of said splines are longitudinally located at the second end of said tool and are angularly located adjacent the corners of said polygonal sides.

31. The tool of claim 27 wherein a portion of the inside surface that is adjacent to the first end forms a transition boundary with the portion of the inside surface that is adjacent to said second end and the portion of the inside surface that is adjacent to said second end generally defines a polygonal frustum having a minor end that is located adjacent to the transition boundary and having a major end that is adjacent to the second end of said tool.

32. The tool of claim 31 wherein the radial difference between the major end and the minor end of the polygonal frustum in proportion to the longitudinal length of the polygonal frustum defines the taper of the polygonal frustum.

33. The tool of claim 32 wherein the taper of said polygonal section is in the range of 4 to 8 degrees.

34. The tool of claim 25 wherein said spline is defined between a crest that is located at a first radial position from the longitudinal center axis of the tool, and also by two roots that are angularly located on opposite sides of the crest, the radial position of each of said roots from the longitudinal center axis of the tool being greater than the radial position of the crest at a given longitudinal position on the longitudinal center axis of the tool.

35. The tool of claim 34 wherein said root and said crest are connected by a side and the angle of the side with respect a radial plane through the crest define a relief angle for the spline at a given longitudinal position of the tool.

36. The tool of claim 34 wherein the difference between the radial position of said crest and the radial position of said root define the depth of said spline, the depth of said spline being substantially constant for all longitudinal positions between the minor end of said conical section and the major end of said conical section.

37. The tool of claim 35 wherein the relief angle of said spline is smaller at the minor end of said conical frustum than the relief angle at the major end of said polygonal frustum.

38. The tool of claim 35 wherein said relief angle is progressively smaller in a longitudinal direction toward the minor end of said polygonal section and is progressively larger in a longitudinal direction toward the major end of said polygonal section.

39. A tool for securing tamper-resistant fasteners, said tool having a generally cylindrical shape and comprising:
a first end;
a second end that is oppositely disposed from the first end;
an outside surface that is defined between the first and second ends, said outside surface adjacent to the first end having a polygonal cross-section and said outside surface adjacent to the second end having a circular cross-section; and
an inside surface that is defined between the first and second ends, said inside surface adjacent to said first end being adapted to receive a drive tool, said inside surface adjacent to said second end having a generally polygonal cross-section, said inside surface adjacent to said second end also defining a central opening with decreasing area as the longitudinal position away from the second end increases, said internal surface adjacent to said second end further including spiral splines having a clockwise orientation and that follow the generally polygonal internal surface.

40. An extrusion die insert that defines a closed internal passageway with one end of said passageway having an opening in the entry end of said extrusion die insert and the other end of said passageway having an opening in the exit end of said extrusion die insert, said die insert comprising:
(a) a first portion that is adjacent to the entry end of said extrusion die, said first portion defining an internal cylindrical surface between first and second ends with the first end of said cylinder having an opening in the entry end of said extrusion die insert;
(b) a second portion that is in communication with the second end of said internal cylindrical surface of said first portion, said second portion defining a circular frustum having inwardly bowed surfaces superimposed thereon, said frustum having a major end and a minor end with the major end of said frustum being in communication with the second end of the cylindrical surface; and
(c) a third portion that is in communication with the minor end of said frustum, said third portion defining an internal polygonal cylinder having a plurality of sides between first and second ends, said sides being connected by radiused joints and the first end of said polygonal cylinder being in communication with the minor end of said frustum.

41. The extrusion die insert of claim 41 wherein the number of inwardly bowed sides in the frustum of said second portion corresponds to the number of sides of the polygonal cylinder of said third portion.

42. The extrusion die of claim 42 wherein the inwardly bowed surfaces of said second portion are bowed in a radially inward direction toward the center of said passageway.

43. The extrusion die of claim 43 wherein an orthogonal cross-section of said frustum defines a chord surface with the ends of the chord touching the circular portion of the frustum and the chord being bowed inwardly towards the center of the passageway along a substantially constant radius of curvature.

44. The extrusion die of claim 42 wherein the internal polygonal cylinder of said third portion defines a substantially constant area along longitudinal positions of said passageway.

45. The extrusion die of claim 43 wherein the radiused joints between the side of the internal polygonal cylinder of said third portion are defined by a constant inner radius of curvature.

46. The extrusion die of claim 40 wherein said passageway is aligned along a longitudinal center axis and wherein at the longitudinal position of the minor end of said frustum and the first end of said third portion of said extrusion die insert, at a given angular position, the radial distance from the longitudinal center axis to the sides of the internal polygonal cylinder is less that the radial distance between the longitudinal center axis and the inner surface of the frustum.

47. The extrusion die of claim 40 wherein said passageway is aligned along a longitudinal center axis and wherein at the longitudinal position where the minor end of said frustum is in communication with the first end of said third portion of said extrusion die insert, at the angular positions of said radiused joints between the side of the internal polygonal cylinder, the radial distance from the longitudinal center axis to the radiused joints is less that the radial distance between the longitudinal center axis and surface of said frustum between the curved surfaces of said frustum.

48. The extrusion die insert of claim 40 wherein said extrusion die insert further includes a second section that defines an internal passageway between first and second ends, the shape of the internal passageway of said second section being in the general shape of a polygonal cylinder with the first end of the polygonal cylinder of said second section being in communication with the second end of the polygonal cylinder of the third portion of said extrusion die insert.

49. The extrusion die insert of claim 48 wherein the polygonal cylinder of said second section has a number of sides that corresponds to the number of sides of the polygonal cylinder of third portion of said extrusion die insert.

50. The extrusion die insert of Clam 49 wherein the sides of the polygonal cylinder of said second section are connected by radiused joints.
